(19) United States
(12) Patent Application Publication
(10) Pub. No.: US 2023/0011369 A1
(43) Pub. Date: Jan. 12, 2023

(54) UNIVERSAL CLOUD BASED SYSTEM FOR TRACKING AND MONITORING MULTI APPLICATIONS ACROSS MULTI-PLATFORMS

(71) Applicant: KAEO Technologies Pte Ltd, Suntec (SG)

(72) Inventor: Luca Buttazzoni, Suntec (SG)

(21) Appl. No.: 17/862,441

(22) Filed: Jul. 12, 2022

Related U.S. Application Data
(60) Provisional application No. 63/220,582, filed on Jul. 12, 2021.

(51) Int. Cl. G06Q 40/02; G06Q 10/10

(52) U.S. Cl. CPC G06Q 40/02; G06Q 10/1097; G06F 3/04847

(57) ABSTRACT

The embodiments herein provide a common/universal multi-platform-based cloud solution/system for tracking and monitoring documents of different categories such as Subscriptions, Warranties, Insurances, Mortgages, Rent, IDs and Visas, Permits and Certificates, etc. several cards corresponding to every category is provided. Every category is a DECK of cards. The user create/review the CARDS representing each document to be tracked and monitored. The user inputs/enters all the information and set a desired time for alerting and reminding about payments and other deadlines/important information. A statistic page displays the total amount spent on each category with averages and sort by/filter by. A Calendar is provided for selecting a date for exhibiting the cards having a payment due on the selected date and the amount due. The due amount for each category such as subscriptions such as premiums, EMIs, etc., are also displayed separately.

### BACKGROUND

### Technical Field

The embodiments herein are generally related to field of document monitoring and tracking systems/applications. The embodiments herein are particularly related to a system for monitoring and tracking plurality of documents of different categories such as Subscriptions, Warranties, Insurances, Mortgages, Rent, IDs and Visas, Permits and Certificates, etc. The embodiments herein are more particularly related to a universal/multi-platform-based cloud system for monitoring and tracking plurality of documents of different categories such as Subscriptions, Warranties, Insurances, Mortgages, Rent, IDs and Visas, Permits and Certificates, etc., in pluralities of platforms.

### Description of The Related Art

The existing Market Players have developed only category-specific APPs, with each APP for a different purpose, layouts, logic, functionalities, etc. thereby forcing us all to go through different learning curves to learn all the features present in each one of those APPs. The current Business Model adopted by these Market Players is therefore neither practical nor effective in addressing, all together, in our documents and payment tracking and monitoring needs.

All those APPs that are currently available, need to be downloaded for tracking and monitoring different category of documents, produce the negative result of cluttering the digital space on the Screen of our Smartphones, thereby draining up phone battery faster (due to added and recurrent background refreshes needed to keep alerts and reminders working). Further these applications consumes/occupies a lot of phone's valuable storage space, thereby forcing everyone to do all the math separately after opening each APP to get the total figure/amount spent on each category.

Hence there is a need for building a multi-platform cloud-based solution/system that breaks down those category-related silos across different groups of documents, thereby finally allowing the user to track and monitor different types/categories of documents in a single place, on the fly, thereby eliminating a need for downloading multiple apps to track and monitor each category of documents separately. Further there is a need for a universal system/platform to extract multiple contents from a plurality of static documents into actionable items, for sending alerts about payments, deadlines and other key actions to be taken based on those items.

The above-mentioned shortcomings, disadvantages and problems are addressed herein, which will be understood by studying the following specifications.

### OBJECTIVES OF THE EMBODIMENTS HEREIN

A primary objective of the embodiments herein is to develop a common/universal multi-platform-based cloud solution/system for tracking and monitoring a plurality of documents of mutually different categories such as Subscriptions, Warranties, Insurances, Mortgages, Rent, IDs and Visas, Permits and Certificates, etc.,

Another objective of the embodiments herein is to develop a common/universal multi-platform-based cloud solution/system for analysing a plurality of mutually different category-related silos across a plurality of mutually different groups of documents, thereby finally allowing the user to track and monitor the plurality of mutually different types/categories of documents in a single place, on the fly, thereby eliminating a need for downloading multiple apps to track and monitor each category of documents separately.

Yet another objective of the embodiments herein is to develop a common/universal multi-platform-based cloud solution/system for tracking and monitoring a plurality of documents of mutually different categories for creating alerts on all the payment deadlines and other key contents embedded in the documents and to remind alert for the needy actions to be executed for all the documents at one place.

Yet another objective of the embodiments herein is to develop a common/universal multi-platform-based cloud solution/system for tracking and monitoring a plurality of documents of mutually different categories by finally accessing all the key information like payments, deadlines, tasks, and a lot of other key data, etc., across a variety of categories of documents such as subscriptions, warranties, insurances, certificates, permits, licenses, identification cards, etc., in just one place.

Yet another objective of the embodiments herein is to develop a common/universal multi-platform-based cloud solution/system for tracking and monitoring a plurality of documents of mutually different categories to provide a statistic page to disclose the details of the total amount spent in that category with averages and to sort by/filter by.

Yet another objective of the embodiments herein is to develop a common/universal multi-platform-based cloud solution/system for tracking and monitoring documents of different categories to provide a Calendar for selecting a date for displaying/exhibiting the cards having a payment due on that date and a due amount to be paid for that card.

Yet another objective of the embodiments herein is to develop a common/universal multi-platform-based cloud solution/system for tracking and monitoring documents of different categories to enable the user to always review statistics and calendar for a specific card, a specific deck of cards or for all the decks and cards together.

Yet another objective of the embodiments herein is to develop a common/universal multi-platform-based cloud solution/system for tracking and monitoring documents of different categories to constantly check for any payment due, deadline or action to be alerted/reminded to the user on a certain date and time.

Yet another objective of the embodiments herein is to develop a common/universal multi-platform-based cloud solution/system for tracking and monitoring documents of different categories to send a push notification and a sound alert/icon alert to notify the User to open the APP to check on the notification.

Yet another objective of the embodiments herein is to develop a common/universal multi-platform-based cloud solution/system for tracking and monitoring documents of different categories to allow multiple categories of documents to coexist in one APP without having to download multiple different APPs,

Yet another objective of the embodiments herein is to develop a common/universal multi-platform-based cloud solution/system for tracking and monitoring documents of different categories to provide an option for sending alerts and reminders for not only about payments but also about “actions to be taken on specific dates” as stated in the contents of the documents.

Yet another objective of the embodiments herein is to develop a common/universal multi-platform-based cloud solution/system for tracking and monitoring documents of different categories to provide a “share with” option to share the contents of each card in-app with other app users and/or with non-app users.

Yet another objective of the embodiments herein is to develop a common/universal multi-platform-based cloud solution/system for tracking and monitoring documents of different categories to, provide a “hide card” option to hide cards that need not be visible to others while looking inside the APP with others thereby preventing the display of contents to others.

Yet another objective of the embodiments herein is to develop a common/universal multi-platform-based cloud solution/system for tracking and monitoring documents of different categories to provide a label system to assign the cards to “personal/business/family & friends/pets”.

Yet another objective of the embodiments herein is to develop a common/universal multi-platform-based cloud solution/system for tracking and monitoring documents of different categories to provide a statistics page outside the decks to select each deck separately or different decks together to get the figures need to be looked at or exported.

Yet another objective of the embodiments herein is to develop a common/universal multi-platform-based cloud solution/system for tracking and monitoring documents of different categories to provide a calendar outside the decks for selecting to show only a specific deck of cards or multiple decks of cards for any given period of time selected.

Yet another objective of the embodiments herein is to develop a common/universal multi-platform-based cloud solution/system for tracking and monitoring documents of different categories in one place thereby eliminating the cluttering of the digital space on the Screen of our Smartphones, and hence the consumption of phone battery charge faster (due to added and recurrent background refreshes needed to keep alerts and reminders working).

Yet another objective of the embodiments herein is to develop a common/universal multi-platform-based cloud solution/system for tracking and monitoring documents of different categories to save a lot of phone's valuable storage space.

Yet another objective of the embodiments herein is to develop a common/universal multi-platform-based cloud solution/system for tracking and monitoring documents of different categories in one place for providing a detailed picture as well as a full picture of all the categories and documents inside just on APP thereby eliminating a need for doing the math separately.

These and other objects and advantages of the embodiments herein will become readily apparent from the following detailed description taken in conjunction with the accompanying drawings.

### SUMMARY

This summary is provided to introduce a brief introduction of concepts related to the embodiments of the present invention. The concepts are further described below in the detailed description. This summary is not intended to identify key features or essential features of the claimed subject matter, nor is it intended to be used to limit the scope of the claimed subject matter.

The various embodiments of the invention provide a common/universal multi-platform-based cloud solution/system for tracking and monitoring a plurality of documents of mutually different categories such as Subscriptions, Warranties, Insurances, Mortgages, Rent, IDs and Visas, Permits and Certificates, etc., According to an embodiment herein, a plurality of cards corresponding to every category is provided. Every category is a DECK of cards. In an exemplary embodiment, a deck of cards for subscriptions is provided with a plurality of cards for subscriptions of each category such as Netflix, Amazon, hot star, software's like Microsoft, adobe, etc., is provided. The user is prompted to create/review the CARDS which represent each document to be tracked and monitored. Inside the CARD (a Netflix subscription in the example here below), the user is prompted/asked to input/enter all the information and to set a desired time for alerting and reminding about payments and other deadlines/important information. A statistic page is provided to display the total amount spent on each category with averages and sort by/filter by. A Calendar is provided for selecting a date for exhibiting the cards having a payment due on the selected date and the amount due. The due amount for each category such as subscriptions such as premiums, EMIs, etc., are also displayed separately.

According to an embodiment herein, each deck of cards has a different color, for identifying and recognizing the category of documents. Further each card in a single deck of cards is also assigned with a mutually different color for identifying and recognizing the category of each document in a given category quickly. In an exemplary embodiment herein, the deck of cards named “subscriptions” is assigned with the color “Blue”, for easy and quick recognition.

According to an embodiment herein, the system of decks of cards allows multiple categories of documents to coexist in one APP without having to download multiple different APPs. The system provides an option for alerting and reminding not only about payments but also about “actions to be taken on specific dates”.

According to an embodiment herein, the system further provides a “share with” option to share the contents of each card in-app with other app users and/or with non-app users. The system still further provides a “hide card” option to hide cards that need not be presented/visible to others while looking inside the APP with \ others so that the cards need not be shown to others are obscured from the preview and purview of others who are not assigned with a right to view or access. The system yet provides a label system to assign the cards to “personal/business/family & friends/pets”.

According to an embodiment herein, a statistics page outside the decks is provided in the system to select each deck separately or different decks together to get the figures need to be looked at or exported.

According to an embodiment herein, a calendar is provided outside the decks in the system to enable the user to select to show only a specific deck of cards or multiple decks of cards for any given/selected period of time.

According to an embodiment herein, the APP/system sends a push notification and a sound alarm or icon notification to notify the User to open the APP to check on the notification, when there is a need/requirement for user intervention.

According to an embodiment a computer implemented method is provided for tracking and monitoring documents of different categories such as Subscriptions, Warranties, Insurances, Mortgages, Rent, IDs and Visas, Permits and Certificates, etc., on a common/universal multi-platform-based cloud solution/system.

According to an embodiment herein, the method comprises the following steps. The User registers in the APP and then is allowed to access a pre-set number of Decks of Cards that are pre-uploaded and developed each to host a specific category of documents. The registered user then is prompted to activate/deactivate the decks that is needed/required or not needed/required at a particular instance. When the registered user turns a deck “ON” than the deck allows the registered user to click on it, enter it and add all the cards that the registered user sees fit or requires to add in that deck (category). The registered user is prompted to just to click on the “+” button for adding more cards and the registered user is directed into the Card where the registered user is provided with multiple fields to be filled in for receiving the required details to be highlighted from the document. The details to be filled in the fields include dates, amounts, qualitative information etc., to be highlighted from the document, as well as to be reminded of with time and date. Most of the fields are free to use—in Freemium mode—while a more featured-rich experience is provided to the users who want to switch to a Paid Account under a chose Plan. The User is permitted/allowed to always review statistics and calendar for a specific card, a specific deck of cards or for all the decks and cards together. The APP works with background refreshes to constantly check if there is any payment, deadline or action due for alerting/reminding the user on a certain date and time. If so, the APP sends a push notification and a sound alarm/icon to notify the User to open the APP to check on the notification.

The embodiments herein provide a common/universal multi-platform-based cloud solution/system for tracking and monitoring documents of different categories such as Subscriptions, Warranties, Insurances, Mortgages, Rent, IDs and Visas, Permits and Certificates, etc., to eliminate a need for downloading multiple APPs anymore to address each the tracking and monitoring needs of each category of documents. The user is enabled to review all documents with in just one APP, by moving inside the APP from category to category and from document to document, without leaving the APP to open different APPs for every category which is the practice now. The system eliminates a need to do the math on the side, as the APP gives a detailed picture as well as a full picture of all the categories and documents inside just on APP.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a screen shot of the system/application displaying the deck of cards and options, according to one embodiment herein.

Although the specific features of the present invention are shown in some drawings and not in others. This is done for convenience only as each feature may be combined with any or all of the other features in accordance with the embodiments herein.

### DETAILED DESCRIPTION OF THE PREFERRED EMBODIMENTS HEREIN

The detailed description of various exemplary embodiments of the present invention is described herein with reference to the accompanying drawings. It should be noted that the embodiments are described herein in such details as to clearly communicate the present invention. However, the amount of details provided herein is not intended to limit the anticipated variations of embodiments; on the contrary, the intention is to cover all modifications, equivalents, and alternatives falling within the spirit and scope of the present invention as defined by the appended claims.

It is also to be understood that various arrangements may be devised that, although not explicitly described or shown herein, embody the principles of the present invention. Moreover, all statements herein reciting principles, aspects, and embodiments of the present invention, as well as specific examples, are intended to encompass equivalents thereof.

While the embodiments of this susceptible to various modifications and alternative forms, specific embodiment thereof has been shown by way of example in the drawings and will be described in detail below. It should be understood, however that it is not intended to limit the present invention to the forms disclosed, but on the contrary, the present invention is to cover all modifications, equivalents, and alternatives falling within the scope of the present invention.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the invention provide a common/universal multi-platform-based cloud solution/system for tracking and monitoring a plurality of documents of mutually different categories such as Subscriptions, Warranties, Insurances, Mortgages, Rent, IDs and Visas, Permits and Certificates, etc., According to an embodiment herein, a plurality of cards corresponding to every category is provided. Every category is a DECK of cards. In an exemplary embodiment, a deck of cards for subscriptions is provided with a plurality of cards for subscriptions of each category such as Netflix, Amazon, hot star, software's like Microsoft, adobe, etc., is provided. The user is prompted to create/review the CARDS which represent each document to be tracked and monitored. Inside the CARD (a Netflix subscription in the example here below), the user is prompted/asked to input/enter all the information and to set a desired time for alerting and reminding about payments and other deadlines/important information. A statistic page is provided to display the total amount spent on each category with averages and sort by/filter by. A Calendar is provided for selecting a date for exhibiting the cards having a payment due on the selected date and the amount due. The due amount for each category such as subscriptions such as premiums, EMIs, etc., are also displayed separately.

According to an embodiment herein, each deck of cards has a different color, for identifying and recognizing the category of documents. Further each card in a single deck of cards is also assigned with a mutually different color for identifying and recognizing the category of each document in a given category quickly. In an exemplary embodiment herein, the deck of cards named “subscriptions” is assigned with the color “Blue”, for easy and quick recognition.

According to an embodiment herein, the system of decks of cards allows multiple categories of documents to coexist in one APP without having to download multiple different APPs. The system provides an option for alerting and reminding not only about payments but also about “actions to be taken on specific dates”.

According to an embodiment herein, the system further provides a “share with” option to share the contents of each card in-app with other app users and/or with non-app users. The system still further provides a “hide card” option to hide cards that need not to be presented/visible to others, while looking inside the APP with\others so that the cards need not be shown to others are obscured from the preview and purview of others who are not assigned with a right to view or access. The system yet provides a label system to assign the cards to “personal/business/family & friends/pets”.

According to an embodiment herein, a statistics page outside the decks is provided in the system to select each deck separately or different decks together to get the figures need to be looked at or exported.

According to an embodiment herein, a calendar is provided outside the decks in the system to enable the user to select to show only a specific deck of cards or multiple decks of cards for any given/selected period of time.

According to an embodiment herein, the APP/system sends a push notification and a sound alarm or icon notification to notify the User to open the APP to check on the notification, when there is a need/requirement for user intervention.

According to an embodiment a computer implemented method is provided for tracking and monitoring documents of different categories such as Subscriptions, Warranties, Insurances, Mortgages, Rent, IDs and Visas, Permits and Certificates, etc., on a common/universal multi-platform-based cloud solution/system.

According to an embodiment herein, the method comprises the following steps. The User registers in the APP and then is allowed to access a pre-set number of Decks of Cards that are pre-uploaded and developed each to host a specific category of documents. The registered user then is prompted to activate/deactivate the decks that is needed/required or not needed/required at a particular instance. When the registered user turns a deck “ON” than the deck allows the registered user to click on it, enter it and add all the cards that the registered user sees fit or requires to add in that deck (category). The registered user is prompted to just to click on the “+” button for adding more cards and the registered user is directed into the Card where the registered user is provided with multiple fields to be filled in for receiving the required details to be highlighted from the document. The details to be filled in the fields include dates, amounts, qualitative information etc., to be highlighted from the document, as well as to be reminded of with time and date. Most of the fields are free to use—in Freemium mode—while a more featured-rich experience is provided to the users who want to switch to a Paid Account under a chose Plan. The User is permitted/allowed to always review statistics and calendar for a specific card, a specific deck of cards or for all the decks and cards together. The APP works with background refreshes to constantly check if there is any payment, deadline or action due for alerting/reminding the user on a certain date and time. If so, the APP sends a push notification and a sound alarm/icon to notify the User to open the APP to check on the notification.

The embodiments herein provide a common/universal multi-platform-based cloud solution/system for tracking and monitoring documents of different categories such as Subscriptions, Warranties, Insurances, Mortgages, Rent, IDs and Visas, Permits and Certificates, etc., to eliminate a need for downloading multiple APPs anymore to address each the tracking and monitoring needs of each category of documents. The user is enabled to review all documents with in just one APP, by moving inside the APP from category to category and from document to document, without leaving the APP to open different APPs for every category which is the practice now. The system eliminates a need to do the math on the side, as the APP gives a detailed picture as well as a full picture of all the categories and documents inside just on APP.

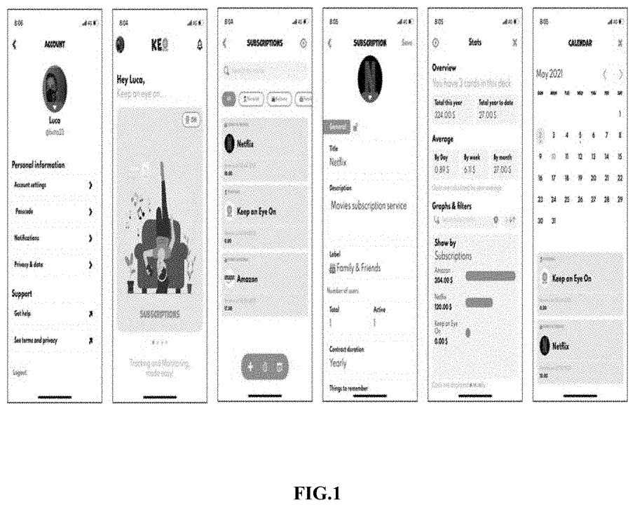

FIG. 1 illustrates a screen shot of the system/application displaying the deck of cards and options, according to one embodiment herein. With respect to FIG. 1, a plurality of cards is provided corresponding to the categories of accounts, subscriptions, and statistics and a user selection page for cards. The User registers in the APP and then is allowed to access a pre-set number of Decks of Cards that are pre-uploaded and developed each to host a specific category of documents. The registered user then is prompted to activate/deactivate the decks that is needed/required or not needed/required at a particular instance. When the registered user turns a deck “ON” than the deck allows the registered user to click on it, enter it and add all the cards that the registered user sees fit or requires to add in that deck (category). The registered user is prompted to just to click on the “+” button for adding more cards and the registered user is directed into the Card where the registered user is provided with multiple fields to be filled in for receiving the required details to be highlighted from the document. The details to be filled in the fields include dates, amounts, qualitative information etc., to be highlighted from the document, as well as to be reminded of with time and date. Most of the fields are free to use—in Freemium mode—while a more featured-rich experience is provided to the users who want to switch to a Paid Account under a chose Plan. The User is permitted/allowed to always review statistics and calendar for a specific card, a specific deck of cards or for all the decks and cards together. The APP works with background refreshes to constantly check if there is any payment, deadline or action due for alerting/reminding the user on a certain date and time. If so, the APP sends a push notification and a sound alarm/icon to notify the User to open the APP to check on the notification.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

Although the embodiments herein are described with various specific embodiments, it will be obvious for a person skilled in the art to practice the embodiments herein with modifications. Although the embodiments herein are described with various specific embodiments, it will be obvious for a person skilled in the art to practice the embodiments herein with modifications.

The scope of the embodiments of the present invention is to be ascertained with the claims to submitted at the time of filing the complete specification.

What is claimed is:

1. A common/universal multi-platform-based cloud solution/system for tracking and monitoring plurality of documents of mutually different categories, comprises:
a plurality of cards corresponding to every category, and wherein every category is a DECK of cards, and wherein a registered user is prompted/asked to input/enter all the information and to set a desired time for alerting and reminding about payments and other deadlines/important information inside the card;
a “share with” option to share the contents of each card in-app with other app users and/or with non-app users;
a “hide card” option to hide the cards that need not be presented/visible to others, while looking inside the APP with\others so that the cards need not be shown to others are obscured from the preview and purview of others who are not assigned with a right to view or access;
a label system to assign the cards to “personal/business/family & friends/pets”;
a statistic page to display the total amount spent on each category with averages and sort by/filter by, and wherein the statistics page outside the decks is provided to select each deck separately or different decks together to get the figures need to be looked at or exported; and
a Calendar for selecting a date for exhibiting the cards having a payment due on the selected date and the amount due, and wherein the due amount for each category such as subscriptions such as premiums, EMIs, etc., are also displayed separately, and a calendar is provided outside the decks in the system to enable the user to select to show only a specific deck of cards or multiple decks of cards for any given/selected period of time;
wherein each deck of cards has a different color, for identifying and recognizing the category of documents, and wherein each card in a single deck of cards is also assigned with a mutually different color for identifying and recognizing the category of each document in a given category quickly, and wherein the system sends a push notification and a sound alarm or icon notification to notify the User to open the APP to check on the notification, when there is a need/requirement for user intervention, and wherein the plurality of documents of mutually different categories of cards include Subscriptions, Warranties, Insurances, Mortgages, Rent, IDs and Visas, Permits and Certificates.

2. A computer implemented method comprising instructions stored on a non-transitory computer readable storage medium and executed on a hardware processor for tracking and monitoring plurality of documents of mutually different categories on a common/universal multi-platform-based cloud solution/system through an application/algorithm (APP), the method comprising the steps of:
registering a User registers in the APP to allow the user to access a pre-set number of Decks of Cards that are pre-uploaded and developed each to host a specific category of documents;
activating/deactivating the decks that is needed/required or not needed/required at a particular instance;
entering and adding all the cards required for the user in that deck (category), When the registered user turns a deck “ON” by a just click operation on the “+” button;
providing multiple cards in the cards to enable the registered user to fill-in the required details to be highlighted from the document, and wherein the details to be filled in the fields include dates, amounts, qualitative information, to be highlighted from the document, as well as to be reminded of with time and date;
sending a push notification and a sound alarm/icon to notify the User to open the APP to check on the notification. When the APP refreshes the background at periodic intervals to check if there is any payment, deadline or action due for alerting/reminding the user on a certain date and time;
wherein most of the fields are free to use—in Freemium mode—while a more featured-rich experience is provided to the users who want to switch to a Paid Account under a chose Plan, and wherein the User is permitted/allowed to always review statistics and calendar for a specific card, a specific deck of cards or for all the decks and cards together, and wherein the plurality of documents of mutually different categories include Subscriptions, Warranties, Insurances, Mortgages, Rent, IDs and Visas, Permits and Certificates.
